(19) United States
(12) Patent Application Publication
(10) Pub. No.: US 2016/0080552 A1
(43) Pub. Date: Mar. 17, 2016

(54) METHODS AND SYSTEMS FOR USER FEATURE TRACKING ON A MOBILE DEVICE

(71) Applicant: Qualcomm Incorporated, San Diego, CA (US)

(72) Inventors: Virginia Walker Keating, San Diego, CA (US); Robert Scott Tartz, San Marcos, CA (US)

(21) Appl. No.: 14/489,396

(22) Filed: Sep. 17, 2014

(51) Int. Cl. H04M 1/725; G06K 9/00

(52) U.S. Cl. CPC H04M 1/72569; G06K 9/00281; G06K 9/00248; G06K 9/00255

(57) ABSTRACT

Disclosed is an apparatus and method for automatically configuring a mobile device based on user feature data. A mobile device can detect a change in orientation from a first to a second orientation based on images captured with a touchscreen of the mobile device. The device may then apply a first configuration to the mobile device when the mobile device is in the second orientation. The detection of the second orientation may include capturing a first image and a second image and extracting user feature data from the images. Once a shift in the extracted user feature data above a threshold indicating motion is detected, the first configuration may then be applied to a mobile device. A third image may also be captured, and if a shift back is detected, an initial configuration may be restored.

### FIELD

The subject matter disclosed herein relates generally to configuring a mobile device based on tracked user features.

### BACKGROUND

When a user is participating in a call on his or her mobile telephone, there are numerous circumstances that draw the user's attention away from the ongoing call. For example, the user may participate in a real-world conversation with another person at the same time as the ongoing call. If the microphone on the mobile telephone remains open while the user converses with the other person, the microphone may pick up content that the user does not want to transmit in the ongoing call.

Users therefore often mute a telephone call in response to real world communication with another person. To manually mute the ongoing call, the user must remove the mobile telephone from their ear, access a screen, potentially sort through call options until mute is found, and manually select to mute the phone. During this time, the user will potentially miss a portion of incoming audio data for the ongoing call. Similarly, when the user has muted the call and needs to speak again (e.g. answer a question on the call), it is can be difficult to quickly unmute the mobile telephone in order to talk. Again, the user may miss a portion of incoming audio when they remove the phone from their ear to unmute the mobile telephone call.

### BRIEF DESCRIPTION OF THE DRAWINGS

FIG. 1A is a flow diagram of one embodiment of a method for configuring a mobile device during a call based on the tracking of one or more user features;

FIG. 1B is a flow diagram of another embodiment of a method for configuring a mobile device during a call based on the tracking of one or more user features;

FIG. 2 is block diagram of one embodiment of a mobile device;

FIG. 3 is a flow diagram of one embodiment of a method for enrolling user ear print feature data for auto-configuration;

FIG. 4 is a flow diagram of one embodiment of a method for automatically muting and un-muting a mobile device during a call based on tracked user features;

FIG. 5 illustrates one embodiment of muting and un-muting a mobile device during a call based on tracked user feature data; and

FIG. 6A illustrates one embodiment of user feature data utilized for determining when a mobile device should not be muted; and

FIG. 6B illustrates one embodiment of user feature data utilized for determining when a mobile device should be muted.

### DETAILED DESCRIPTION

Methods and systems are disclosed herein for automatically configuring a mobile device based on user feature data. In one embodiment, the mobile device may be a mobile telephone, a smartphone, or any other mobile device. For ease of discussion, the remaining description will utilize the terms mobile device and mobile telephone interchangeably, and not by way of limitation.

In one embodiment, in response to a telephone call being initiated or received on a mobile telephone, the mobile telephone attempts to extract an image of the ear of the user participating in the mobile telephone call. As discussed below, the relative position of the ear with respect to the screen of the mobile telephone is determined to detect when a microphone of the mobile telephone should be muted or unmuted. In one embodiment, the relative position of the ear enables inferences about a user, such as a relative position of a mouth of the user with respect to the phone, to be made. For example, when the mobile phone is shifted away from the user's mouth as determined by the change in relative ear position, the microphone is automatically muted. Similarly, when the mobile phone is shifted back to the user's mouth as determined by another change in relative ear position, the microphone is automatically unmuted.

In one embodiment, a user typically places the mobile telephone to their ear in order to participate in an incoming or outgoing telephone call. In one embodiment, a multi-touch screen of the mobile telephone, such as a capacitive touch sensitive screen, resistive touch sensitive screen, etc. of the mobile device, captures an initial image of the user and extracts user feature data from the initial image. In one embodiment, the initial image is an image of the user's ear captured from the multi-touch screen, and the user feature data may include one or more of an ear profile shape, angle of the anti-helix relative to the phone, curvature of the anti-helix, location of the tragus relative to the anti-helix, upper ear profile, or lobe profile, or any combination thereof. In one embodiment, the initial image, and position of the user feature data relative to the mobile telephone's multi-touch screen, is stored as a reference image. In one embodiment, data indicative of the user image and extracted user feature data may be stored as a biometric signature, feature vector, or other user identifier.

In one embodiment, the mobile telephone periodically captures additional images of the ear of the user with the multi-touch screen during the call. The new images of the ear, and relative positioning of user feature data extracted from the new images, are compared against the initial image and relative position of feature data, to determine if a shift has occurred. In one embodiment, the determined shift includes determining an amount of rotation that has occurred with respect to user feature data. That is, if the user feature data has rotated at least θ degrees, which is indicative of a movement of a microphone away from a user's mouth, an audio input of the mobile telephone is muted. In one embodiment, the image utilized to determine the shift is stored as a shifted image by the mobile telephone.

Images of the user's ear are continuously or periodically sampled, and features extracted from the images are compared with the features extracted from the shifted image. In one embodiment, the comparison is utilized to determine when a change in relative position of the user's extracted feature data indicates that a shift has occurred back towards the user's mouth. In one embodiment, when it is determined that the ear has rotated back at least φ degrees, the device is unmuted and a reference image is again stored.

Although mute and unmute are discussed above, in one embodiment, the sensitivity of the mobile telephone's microphone can be periodically adjusted as a function of the shift away from, or towards, the user's mouth. For example, the greater the shift away from the user's mouth up to the angle θ, the more the microphone sensitivity is reduced. Similarly, the greater the shift back to the user's mouth up to angle φ, the more the microphone sensitivity is increased. However, when the shift reaches the appropriate threshold, such as a rotation of θ or φ degrees, the audio input of the mobile telephone is muted or un-muted. As another example, the sensitivity of the microphone may be increased the greater the shift away from the user's mouth, and decreased as the microphone shifts back to the user's mouth. In one embodiment, the determination as to how the microphone sensitivity is adjusted based on detected shift may be selected by a user, or pre-configured by a telephone manufacturer.

In one embodiment, a user may enroll for auto mute and un-mute on a mobile telephone prior to placing or receiving a call. The mobile telephone captures one or more ear-print images associated with the user in a position that simulates the user talking during a call. The captured ear-print image(s) are then associated with a user identifier, and user preferences associated with the user identifier. Similarly, one or more shifted ear print images, such as when the microphone is shifted away from the user's mouth, could also be captured by the mobile telephone and associated with the user identifier. In one embodiment, and as discussed in greater detail below, the ear print images captured during user enrollment enable a mobile device to determine a current user of the mobile device and associate the current user with the appropriate user identifier.

In one embodiment, configuration options may be selected by a user and associated with the user identifier generated from user's enrolled ear print images. For example, a maximum and/or minimum angle of shift for auto muting and unmuting a microphone during a call could be selected by a user and associated with the template and/or shifted template. As another example, speaker volume could be associated with a user's ear print template. In one embodiment, when the initial image discussed above is matched against an enrolled user template, the mobile telephone can automatically apply the user preferences and/or options to a mobile device during a call.

Embodiments discussed herein may include configuring a mobile device based on captured user feature data and detected shifts in the user feature data during a telephone call. However, the techniques for configuring the mobile device, as discussed herein, need not be limited to the context of mobile telephone calls. In embodiments, the mobile device need not be a mobile telephone, and the mobile device may be configured during dictation operations, when audible commands are given to a mobile device, when receiving commands or information from the mobile device, as well as other user-mobile device interactions. For example, a personal assistant device's microphone may be muted based on captured and/or shifted feature data to avoid confusion with audible command entry. As another example, a mobile device's microphone may be muted based on captured and/or shifted feature data to keep the mobile device from entering a comment during dictation. The remaining description will illustrate the techniques for configuring a mobile device during a telephone call. However, the techniques discussed herein are not to be limited to telephone calls, as any user-mobile device interaction may utilize the techniques discussed herein.

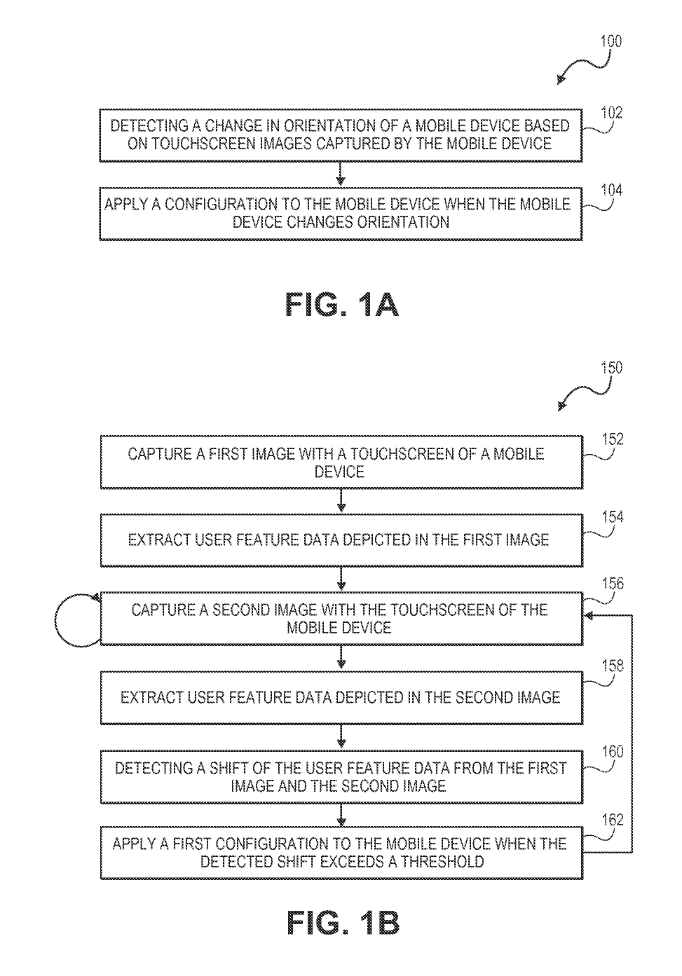

FIG. 1A is a flow diagram of one embodiment of a method 100 for configuring a mobile device during a call based on the tracking of one or more user features. The method 100 is performed by processing logic that may comprise hardware (circuitry, dedicated logic, etc.), software (such as is run on a general purpose computer system or a dedicated machine), firmware, or a combination.

Referring to FIG. 1A, processing logic begins by detecting a change in orientation of a mobile device based on touchscreen images captured by the mobile device (processing block 102). In one embodiment, as discussed herein, the mobile device is a mobile telephone with a touchscreen, processor, memory, audio input, audio output, and other components typically included with mobile telephones. In one embodiment, the touchscreen captures images of a user at the initiation of a telephone call, and periodically captures additional touchscreen images throughout a telephone call. In one embodiment, the mobile device tracks user features, as depicted in the captured touchscreen images, to determine a first orientation of the mobile device relative to a telephone conversation. Furthermore, in one embodiment, an initial configuration of one or more mobile device components is applied to the mobile device to enable the user to participate in the telephone conversation. For example, the configuration can include an audio input remaining unmuted, an audio output set at a predetermined level, etc., while in the mobile device remains in the first orientation relative to the telephone conversation.

In one embodiment, from the periodically captured touchscreen images, processing logic is able to detect when the mobile device changes to a second orientation different from the first orientation. Processing logic applies a first configuration to the mobile device when the mobile device changes orientation (processing block 104). For example, when the mobile device changes orientation, processing logic can infer that the mobile device has shifted from an orientation associated with participation in the ongoing telephone conversation to a different orientation associated with non-participation in the ongoing telephone conversation. In this example, the mobile device may be rotated, translated, or otherwise shifted causing a corresponding shift of the user features in the captured touchscreen images. From this detected shift, processing logic can infer that the mobile device has changed orientation relative to an ongoing telephone conversation, and apply a different configuration (for example, a first configuration that is different from an initial configuration) to the mobile device, such as muting an audio input of the mobile device relative to the ongoing telephone conversation. As will be discussed in greater detail below, different orientations can be associated with different mobile device configurations, enabling processing logic to switch between the configurations in response to detected shifts between the different orientations.

FIG. 1B is a flow diagram of another embodiment of a method 150 for configuring a mobile device during a call based on the tracking of one or more user features. The method 150 is performed by processing logic that may comprise hardware (circuitry, dedicated logic, etc.), software (such as is run on a general purpose computer system or a dedicated machine), firmware, or a combination.

Referring to FIG. 1B, processing logic begins by capturing a first image with a touchscreen of a mobile device (processing block 152). In one embodiment, the mobile device is a mobile telephone. However, other mobile communications devices, which have a built in speaker and microphone for enabling a user to participate in voice communication, may be utilized according to the discussion herein. In one embodiment, the image can be captured in response to a telephone call received or initiated by the mobile device.

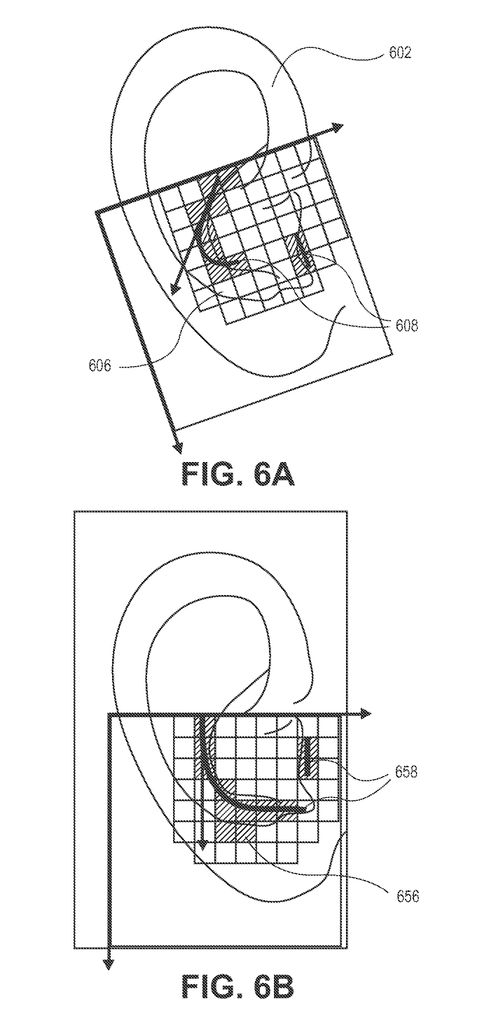

Furthermore, in one embodiment, as discussed in greater detail herein, the mobile device includes a multi-touch screen, such as a capacitive touch sensitive screen, resistive touch sensitive screen, etc. that enables a user to interact with the mobile device through touch. The user touches may include touches by a user's finger, face, ear, etc. Typically, in response to a telephone call event, a user would place the mobile device to his or her ear to participate in the telephone call. In one embodiment, the first image captured by processing logic captures an image of the user's ear and/or face. As illustrated in FIG. 6A, at the initiation of a telephone call, a mobile device is placed to user's ear 602. In one embodiment, processing logic captures a first touchscreen image 606 of the user's ear 602, which are the parts of the user's ear that are in contact with the touchscreen of mobile device.

Processing logic then extracts user feature data depicted in the image (processing block 154). In one embodiment, the features detected in the touchscreen image are user features 608 extracted from the first touchscreen image 606 of the user's ear 602. In one embodiment, the orientation and positioning of the extracted user features are detected relative to a position of the mobile device.

A second image is captured with the touchscreen of the mobile device (processing block 156), and processing logic extracts user feature data as depicted in the second captured image (processing block 158). In one embodiment, the second image is a second touchscreen image and the orientation and positioning determined using the extracted user features in the second touchscreen image are utilized by processing logic to detect a shift of the user feature from the first image and the second image (processing block 160). In one embodiment, processing logic determines a movement of user features as depicted in the touchscreen images relative to the touchscreen of the mobile device based on a comparison of the user feature data extracted from the first image with the user feature data extracted from the second image. In one embodiment, processing logic samples touchscreen images at processing block 106 on a periodic basis, such as every 0.1 seconds, every 0.5 seconds, every 1 second, etc., to enable processing blocks 108 and 110 to track the movement of the user's feature in real-time during an ongoing telephone call. In one embodiment, the tracking of the user's feature enables processing logic to determine and track a rotation of the user's feature, translation of the user's feature, or both, as well as other forms of movement of the user's feature relative to the mobile phone.

In one embodiment, as discussed in greater detail below, the tracked movement is a rotational movement of the at least one user's feature relative to the touchscreen of the mobile device. As illustrated in FIG. 6B, user features 658 extracted from the second touchscreen image 656 corresponding to user features 608 extracted from the initial touchscreen image 606 in FIG. 6A are determined by processing logic to have moved, and in particular to have rotated relative to mobile device. In one embodiment, the determination that the user features 658 extracted from the second touchscreen image 656 have rotated in the different touchscreen images, 606 and 656, enables processing logic to infer that an audio input of the mobile device has shifted away from a user's mouth in an ongoing telephone call.

A configuration is then applied to the mobile device when the detected shift exceeds a threshold (processing block 162). In one embodiment, where the shift is a rotational movement relative to the touchscreen of the mobile device, processing logic determines when the rotational movement exceeds a first rotational movement threshold, such as rotation beyond N degrees. In another embodiment, wherein the movement is a translational movement relative to the touchscreen of the mobile device, processing logic determines when the movement exceeds a translational movement threshold. In either embodiment, the threshold may be a default threshold or set through user selection. Furthermore, the threshold enables processing logic to infer that the location of the audio input has shifted away from the user's mouth a sufficient amount such that the mobile device should be configured. In one embodiment, processing logic configures the mobile device by muting the audio input of the mobile device when the movement threshold is exceeded. In one embodiment, the audio output of the mobile remains unchanged, to enable a user to continue listening to the ongoing call.

Processing logic returns to processing block 156 to continue to sample touchscreen images, detect user features, and determine movement of those features relative to the touchscreen of the mobile device. In one embodiment, the continued monitoring enables processing logic to capture additional images, such as a third touchscreen image used to detect additional movement from extracted user feature data. In one embodiment, rotation of the user feature may be detected in a second direction by comparison of the second touchscreen image and the third touchscreen image. In one embodiment, processing logic determines, from the movement of the user features in the additional touchscreen images, to un-mute the mobile device when the audio input moves back to the user's mouth, such as when a second rotational movement of the user feature data determined from the second and third touchscreen images exceeds a second rotational threshold. For example, when the rotational movement indicates that the user feature has rotated back to a position of the user feature as depicted in the first touchscreen image, such as a talking position, processing logic can return the mobile device to an original configuration or a different configuration associated with the second rotational threshold. For example, the mobile device may transition back to the talking position illustrated in FIG. 6A from the non-talking position of FIG. 6B. In one embodiment, the process of applying different mobile device configurations, such as by muting and un-muting the mobile device, based on tracked user features, continues until the telephone call is terminated

In one embodiment, processing logic configures the mobile device by automatically muting and un-muting an audio input of the mobile device during an ongoing call. However, other components of the mobile device may be automatically configured in a manner consistent with the discussion herein. For example, audio output volume, call status, touchscreen brightness, as well as other components of the mobile device may be automatically configured based on the tracked movement of user features.

Furthermore, the mobile device may be configured to receive and/or execute commands based on the tracked movement of user features and detected shifts in user features. For example, a mobile device shifting away from a user's mouth during a telephone call may indicate that captured audio data should not be transferred during an ongoing call, but instead a command should be entered and/or processed by the mobile device. For example, a mobile device may capture the audio “yes, dinner sounds like fun” while the audio input of the mobile device (for example, the microphone) is detected or inferred to be near a user's mouth. This captured audio data would be transferred as call audio data based on the tracked user features. However, when a detected shift away from the user's mouth is detected, the mobile device could be configured to process any received audio as a user command, such as “set meeting for Saturday at 8 PM, dinner with neighbors.” The mobile device would configure one or more applications, such as a calendar application, mail application, etc. based on this command. Then, when a shift in the mobile device is detected back to a talking position, captured audio could again be transferred to the caller.

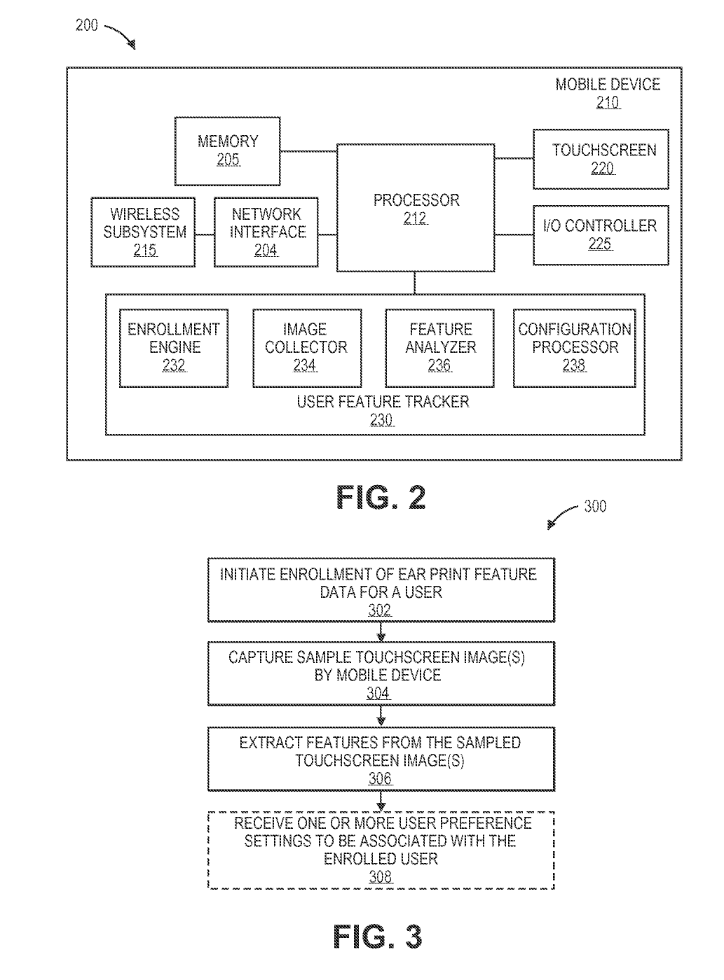

FIG. 2 is block diagram of one embodiment 200 of a mobile device 210. In one embodiment, mobile device 210 is a system, such as a mobile telephone, which may include one or more processors 212, a memory 205, I/O controller 225, touchscreen 220, network interface 204, and display (which may be integrated with touchscreen 220). Mobile device 210 may also include a number of processing modules, which may be implemented as hardware, software, firmware, or a combination, such as the user feature tracker 230, which includes enrollment engine 232, image collector 234, feature analyzer 236, and configuration processor 238. It should be appreciated that mobile device 210 may also include, although not illustrated, a power device (e.g., a battery), an audio input and audio output (e.g., a microphone and speaker controlled by I/O controller 225), as well as other components typically associated with electronic devices. Network interface 204 may also be coupled to a number of wireless subsystems 215 (e.g., Bluetooth, WiFi, Cellular, or other networks) to transmit and receive data streams through a wireless link. In one embodiment, wireless subsystem 215 communicatively couples mobile device 210 to wearable device.

In one embodiment, memory 205 may be coupled to processor 212 to store instructions for execution by the processor 212. In some embodiments, memory 205 is non-transitory. Memory 205 may store user feature tracker 230 to implement embodiments described herein. It should be appreciated that embodiments of the invention as will be hereinafter described may be implemented through the execution of instructions, for example as stored in memory or other element, by processor 212 of mobile device 210, and/or other circuitry of mobile device 210. Particularly, circuitry of mobile device 210, including but not limited to processor 212, may operate under the control of a program, routine, or the execution of instructions to execute methods or processes in accordance with embodiments of the invention. For example, such a program may be implemented in firmware or software (e.g. stored in memory 205) and may be implemented by processors, such as processor 212, and/or other circuitry. Further, it should be appreciated that the terms processor, microprocessor, circuitry, controller, etc., may refer to any type of logic or circuitry capable of executing logic, commands, instructions, software, firmware, functionality and the like.

In one embodiment, enrollment engine 232 of user feature tracker 230 is responsible for causing image collector 234 to capture one or more touchscreen images of a user prior to receiving or placing a telephone call. In one embodiment, the images are captured during the enrollment process discussed below in FIG. 3. The touchscreen images may include one or more images captured by touchscreen 220 of the mobile device 210 when the mobile device 210 is in a talking position and/or a non-talking position. For example, in a talking position, the mobile device 210 would be pressed to a user's ear and an audio input positioned relatively close to the user's mouth. Furthermore, in the non-talking position, the mobile device 210 would likely still be pressed to a user's ear and the audio input rotated away from the user's mouth. The one or more touchscreen images may then be saved in memory 205 and associated with a user. Furthermore, during the enrollment process for a user, feature analyzer 236 may extract one or more features from the touchscreen images, such as identifying features from a user's ear captured in the touchscreen images. In one embodiment, these features may be stored as a feature vector, biometric signature, or template, which can be utilized by user feature tracker 230 to identify a user during a call, recall the user-specific talking position and non-talking position images, as well as to apply one or more user selected preferences.

In one embodiment, user feature tracker 230 is responsible for determining when a call occurs on mobile device 210. As discussed herein, the call may be an incoming or an outgoing call. In response to detection of a call, image collector 234 is triggered to capture an initial touchscreen image of a user participating in the call. As discussed herein, user features may be extracted by feature analyzer 236 from the initial image, and used to determine if an enrolled user is participating in a call by matching the extracted features from features extracted during an enrollment process. After feature analyzer 236 determines that a match has been found, configuration processor 238 applies any call preferences associated with an identified user to the call. In one embodiment, a user need not be enrolled to utilize the automatic configuration discussed herein. However, enrollment is a precondition to application of call specific preferences, such as applying a pre-set call volume, applying user-selected mute and un-mute rotation thresholds, selection of hard mute and un-mute of an audio input of mobile device 210, selection of a continuous incremental adjustments of the audio input of mobile device 210, as well as other device configuration options.

During a call, image collector 234 is responsible for periodically sampling touchscreen images of a user participating in the call. In one embodiment, image collector 234 causes touchscreen 220 to capture an image of the user's ear and/or face from simultaneous raw touch sensor data. The captured image is then provided to feature analyzer 236, which extracts user feature data from the captured image. For example, the user feature data may correspond to ear feature data, such as ear profile shape, angle of a user's anti-helix relative to the touchscreen 220 of mobile device 210, curvature of the anti-helix, location of the user's tragus relative to the anti-helix and/or relative to the touchscreen 220 of mobile device 210, the user's upper ear detail, ear canal shape, lobe detail, face data relative to one or more ear features, etc. In one embodiment, the user feature data may correspond to a capacitive image profile of the user's ear and/or face. In one embodiment, the capacitive image profile is a distribution of relative capacitance levels across the touched area measured from capacitive touch sensors, which is unique to the facial and/or ear features of each user.

Configuration processor 238 is responsible for tracking the user feature data, extracted by feature analyzer 236 during an ongoing call. In one embodiment, configuration processor 238 analyzes movement of one or more of the tracked features, such as rotational movement, translational movement, etc. relative to the touchscreen 220 of mobile device 210. In one embodiment, the tracked relative movement of the user's features enables configuration processor 238 to infer a location of the user's mouth relative to an audio input of the mobile device 210. For example, when the user features have rotated a threshold number of degrees θ, configuration processor 238 can infer that the position of the audio input is no longer close to a user's mouth and the mobile device has shifted from a talking to a non-talking position. Similarly, when the user features rotate back a threshold number of degrees φ, configuration processor 238 can infer that the position of the audio input has moved back to the user's mouth and the mobile device has shifted back to a talking position. Configuration processor 238 can apply similar thresholding to other types of movements, such as linear translation of user features relative to touchscreen 220 beyond a certain distance. Configuration processor 238 can apply thresholding for multiple types of movements, for example, both rotation and translation.

In one embodiment, when configuration processor 238 detects a specific type of movement and/or determines that the threshold amount of movement has been met, configuration processor 238 performs one or more configuration operations, such as applying different configurations to the mobile device 210. In one embodiment, hard mute and un-mute thresholds can be used as different mobile device configurations, such that the sensitivity of a microphone is unchanged until the mute and un-mute thresholds are satisfied and the corresponding configurations applied by configuration processor 238. In another embodiment, continuous mute and un-mute threshold can be used as additional mobile device configuration options, such that sensitivity of the microphone is continuously and incrementally lowered as the user's features are determined to be rotating towards the mute threshold θ. Similarly, the sensitivity of the microphone is continuously and incrementally increased as the user's features are determined to be rotating towards the un-mute threshold φ. In yet another embodiment, the sensitivity of the microphone may be increased the greater the shift away from the user's mouth, and decreased as the microphone shifts back to the user's mouth. In any of the embodiments, configuration processor 238 can provide notice to a user, such as by causing a sound tone to be played, causing mobile device 210 to vibrate, causing a visual notification to be displayed, etc. when mobile device is muted or un-muted.

FIG. 3 is a flow diagram of one embodiment of a method 300 for enrolling user ear print feature data for auto-configuration. The method 300 is performed by processing logic that may comprise hardware (circuitry, dedicated logic, etc.), software (such as is run on a general purpose computer system or a dedicated machine), firmware, or a combination. In one embodiment, the method 300 is performed by a mobile device (e.g., mobile device 210).

Referring to FIG. 3, processing logic begins by initiating enrollment of ear print feature data for a user (processing block 302). As discussed herein, enrollment of a user enables automatic user-specific configuration of a mobile device during a call, and can be accomplished prior to a telephone call. Processing logic captures sample enrollment touchscreen image(s) by a mobile device (processing block 304). In one embodiment, a first set of one or more enrollment touchscreen image(s) are collected when a user places the mobile device to their ear to simulate talking with a receiving party. In one embodiment, a second set of one or more shifted enrollment touchscreen image(s) may be collected when the user places the mobile device to their ear to simulate a non-talking position, such as when the mobile device is moved away from their mouth but still in a position that enable the user to listen to an ongoing call.

Features are extracted from the sampled touchscreen image(s) (processing block 306). In one embodiment, a user identifier, such as a template, biometric signature, feature vector, etc., is created from the user features extracted from the touchscreen image(s) for the set of talking position images and optional non-talking position images. In one embodiment, multiple users may be enrolled for automatic configuration on a single mobile device. Thus, as discussed below, the template, biometric signature, feature vector, etc. may be utilized as unique user identifiers to distinguish between different users from, for example, ear features, relative positioning of different ear features, positioning of ear features relative to facial features, etc., of the different users. Furthermore, when both talking position and non-talking position images are captured, user-specific mute and un-mute thresholds may be determined from the difference in shift, rotation, translation, etc. between the extracted user features in the two sets of images.

Processing logic then receives one or more user preference settings to be associated with the enrolled user (processing block 308). In one embodiment, additional configuration settings may optionally be specified by a user during the enrollment process. For example, minimum and/or maximum angles of rotation for automatic configuration can be selected by a user, a default device volume, whether or not to play an audio tone when auto configuring a mobile device, etc. may be specified by the user.

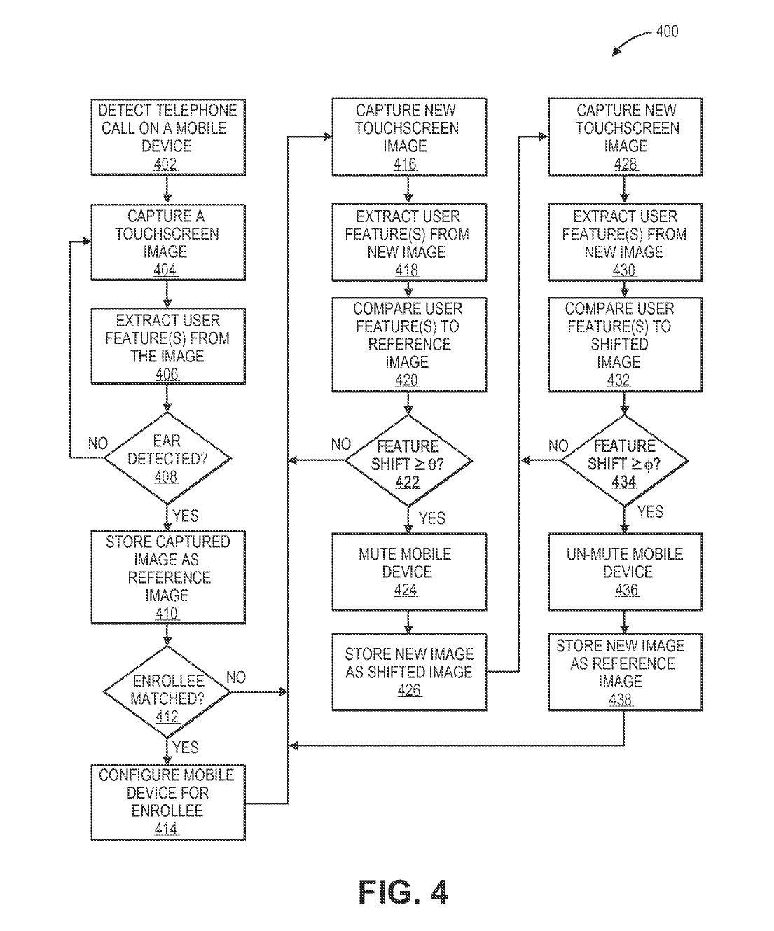

FIG. 4 is a flow diagram of one embodiment of a method 400 for automatically muting and un-muting a mobile device during a call based on tracked user features. The method 400 is performed by processing logic that may comprise hardware (circuitry, dedicated logic, etc.), software (such as is run on a general purpose computer system or a dedicated machine), firmware, or a combination. In one embodiment, the method 400 is performed by a mobile device (e.g., mobile device 210).

Referring to FIG. 4, processing logic begins by detecting a telephone call on a mobile device (processing block 402). A touchscreen image is captured (processing block 404), and one or more user features are extracted from the image (processing block 406). In one embodiment, the captured touchscreen image is an initial reference image in the automatic configuration process. Processing logic extracts features from the touchscreen image in order to determine a location and position of the features relative to the touchscreen of a mobile device. Furthermore, processing logic will utilize the extracted features, as discussed below, to determine if the features match an enrolled user.

Processing logic determines whether an ear is detected in the extracted feature data (processing block 408). In one embodiment, processing logic analyzes the extracted features to determine the presence, location, and/or relationship between an earlobe, tragus, anti-tragus, helix, anti-helix, or other ear features. In one embodiment, the process should not be limited to the use of ear features, as other user features may be extracted from the touchscreen images and utilized in accordance with the discussion herein.

When an ear is not detected in the touchscreen image, the process returns to processing block 404 to capture additional images. However, when an ear is detected, processing logic stores the captured image as a reference image (processing block 410). Alternatively, processing logic may generate a feature vector, biometric template, or other representation of the ear feature data extracted from the touchscreen image. In embodiments, the feature vector, biometric template, etc. may be stored along with the reference image, or stored in place of the reference image.

From the stored reference image and/or feature vector, biometric signature, template, etc., processing logic determines if there is a match with an enrollee (processing block 412). When there is match, processing logic configures the mobile device for the enrollee (processing block 414). In one embodiment, the configuration may include selecting a continuous audio input adjustment mode, selecting user-selected mute and un-mute thresholds, setting user notification options, setting a selected mobile device volume, etc.

When the user is not matched, or after the mobile device is configured for an enrolled user, processing logic proceeds to perform automatic muting and un-muting based on the tracked movement of user features in touchscreen images. In one embodiment, when an ear is detected but no user match is found, a default set of muting and unmuting configurations, such as default shift angles θ_{d} and φ_{d}, may be utilized by processing logic to configure the mobile device.

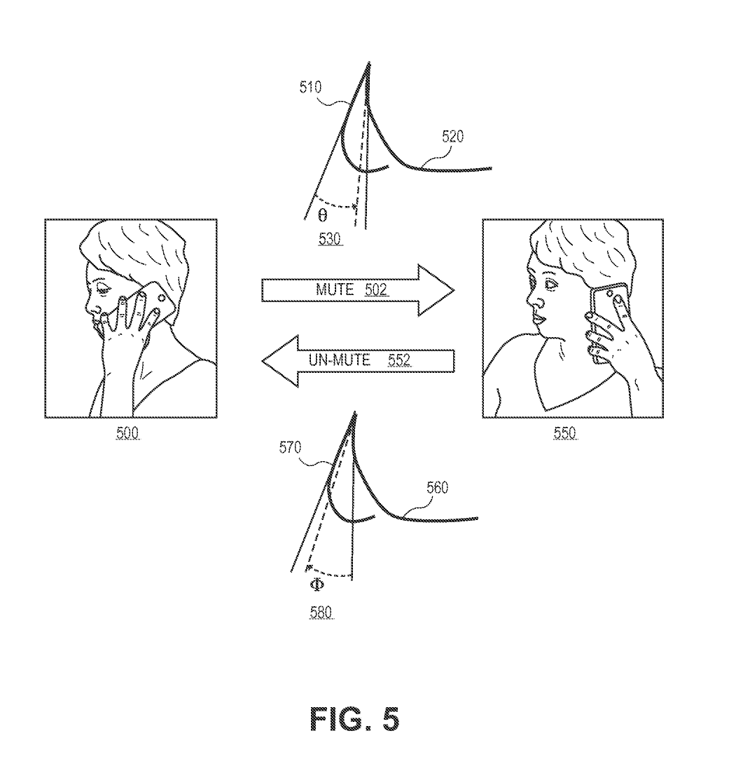

FIG. 5 illustrates muting and un-muting the mobile device during a call. A user is illustrated in a talking position 500 during a call on a mobile device. In talking position 500, an audio input of the mobile device is open for the user to communicate with a party on the other end of the ongoing call. As discussed below in FIG. 4, touchscreen images are captured to detect a user feature shift during a call. As illustrated, an ear feature 510 of a user rotates to position 520 during a call. When the rotation exceeds θ degrees 530, processing logic of FIG. 4 infers that the mobile device is in a non-talking position 550, and the audio input portion of the call is muted 502. Similarly, when the user is in a non-talking position 550, touchscreen images are again captured to detect a user feature shift during the call. When the user feature 560 rotates back to position 570, and the rotation exceeds φ degrees 580, processing logic of FIG. 4 infers that the mobile device has moved back to talking position 500, and the audio input portion of the call is un-muted 552.

Returning to FIG. 4, processing logic captures a new touchscreen image (processing block 416). User features are extracted from the new image (processing block 418) and compared to features from the reference image (processing block 410). Processing logic utilizes the comparison to determine whether there has been a shift in the user feature(s) greater than, or equal to, a threshold θ (processing block 422). In one embodiment, the determination of shift, such as rotation, translation, etc., is determined relative to the touchscreen of the mobile device. Thus, when the rotation, translation, etc. exceeds threshold θ, processing logic infers that an audio input of the mobile device is in a non-talking position relative to a user's mouth, and processing logic mutes the audio input of the mobile device (processing block 424). In one embodiment, although not illustrated, processing logic may generate a notification to the user when the device has been muted, such as by playing a sound or audio tone in an audio output of the mobile device, causing the mobile device to vibrate, a visual indication of the state of the mobile device displayed by the mobile device, or activating a user interface element, or any combination therefore. In one embodiment, the threshold, θ, may be a default threshold, a threshold selected by an enrolled user, a threshold based on extracted user feature data, a threshold may be set by a mobile device manufacturer, etc. For example, a user's ear shape and/or size may be used to identify a type of user, such as a child user verses an adult user. Then, specific user type thresholds may be applied as discussed herein. If the user is determined to be a child, from ear size, enrollee status, etc., corresponding mobile device configuration could increase microphone sensitivity as the phone shifts away from the child's mouth, due to children often dropping the angle of the mobile device inadvertently during a call. In one embodiment, the mobile device's audio output is not muted to enable a user to hear the ongoing call even when the mobile device's microphone is muted.

However, when the threshold shift is not reached, processing logic returns to processing block 416 to capture a new touchscreen image. In one embodiment, until the mobile device is muted at processing block 424, processing logic captures and analyzes new touchscreen images on a periodic basis, such as every half second.

In response to the muting of a call at processing block 424, processing logic stores the new image as a shifted image (processing block 426). In one embodiment, the shifted image is utilized by processing logic as a reference image, as discussed above. Processing logic then captures a new touchscreen image (processing block 428), extracts user feature(s) from the new image (processing block 430), and compares the extracted user feature(s) to the features extracted from the shifted image (processing block 432).

When the shift in the extracted features, such as a rotational movement, translational movement, etc. relative to the touchscreen of the mobile device, meets or exceeds threshold φ, processing logic un-mutes the audio input of the mobile device (processing block 436). In one embodiment, the user may again be notified that the mobile device has been un-muted by playing a sound, causing the mobile device to vibrate, activating a user interface element, etc. In one embodiment, the un-mute notifications may be different from the mute notifications. For example, the mobile device may play a first tone accompanied by a short vibration when muted, but play a second tone accompanied by two short vibrations when un-muted. Furthermore, and similar to the discussion above, when the feature shift does not exceed φ, new touchscreen images are periodically captured and analyzed. In one embodiment, the movement tracked by processing logic and analyzed with respect to threshold φ represents a shift back to an initial talking position. That is, in response to detecting rotational movement, translational movement, or both, etc. back to the original talking position, processing logic infers that the audio input of the mobile device has moved back to the user's mouth, and the new image is stored is a reference image representing the mobile device in a talking position (processing block 438). The process then returns to processing block 416.

In one embodiment, processing blocks 416-438 continue to be performed by processing logic for the duration of a call. The process, however, may terminate at any processing block when an ongoing call is terminated. In one embodiment, when a user is not matched to an enrolled user at processing block 412, processing logic may trigger the enrollment process of FIG. 3 after the call is terminated, and may optionally utilize the touchscreen images captured during the process of FIG. 4 for the user enrollment process.

Furthermore, although not illustrated in FIG. 4, users often remove a mobile device from their ear during an ongoing call, without terminating the call. For example, the user may want to hear a nearby person instead of a caller, and thus the user removes the phone from their ear. In one embodiment, when the processing logic of FIG. 4 determines, at any of processing blocks 414-438, that user feature data is no longer detected, the current device configuration is maintained until the user's feature data is again detected. For example, if a microphone is muted when the phone is removed from a user's ear, the microphone will remain muted. Similarly, when the microphone is un-muted when the phone is removed from a user's ear, the microphone will remain un-muted. Then, when the user's feature data is again detected, the processing logic may configure the mobile device based on detected shifts in user feature data, as discussed above.

It should be appreciated that when the devices discussed herein are mobile or wireless devices, they may communicate via one or more wireless communication links through a wireless network that are based on or otherwise support any suitable wireless communication technology. For example, in some aspects a computing device or server may associate with a network including a wireless network. In some aspects the network may comprise a body area network or a personal area network (e.g., an ultra-wideband network). In some aspects the network may comprise a local area network or a wide area network. A wireless device may support or otherwise use one or more of a variety of wireless communication technologies, protocols, or standards such as, for example, CDMA, TDMA, OFDM, OFDMA, WiMAX, and Wi-Fi. Similarly, a wireless device may support or otherwise use one or more of a variety of corresponding modulation or multiplexing schemes. A mobile wireless device may wirelessly communicate with other mobile devices, cell phones, other wired and wireless computers, Internet web-sites, etc.

The teachings herein may be incorporated into (e.g., implemented within or performed by) a variety of apparatuses (e.g., devices). For example, one or more aspects taught herein may be incorporated into a phone (e.g., a cellular phone), a personal data assistant (PDA), a tablet, a mobile computer, a laptop computer, a tablet, an entertainment device (e.g., a music or video device), a headset (e.g., headphones, an earpiece, etc.), or any other suitable device.

In some aspects a wireless device may comprise an access device (e.g., a Wi-Fi access point) for a communication system. Such an access device may provide, for example, connectivity to another network (e.g., a wide area network such as the Internet or a cellular network) via a wired or wireless communication link. Accordingly, the access device may enable another device (e.g., a Wi-Fi station) to access the other network or some other functionality. In addition, it should be appreciated that one or both of the devices may be portable or, in some cases, relatively non-portable.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in random-access memory (RAM), flash memory, read-only memory (ROM), erasable programmable read-only memory (EPROM), electronically erasable programmable read-only memory (EEPROM), registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software as a computer program product, the functions may be stored on or transmitted over as one or more instructions or code on a non-transitory computer-readable medium. Computer-readable media can include both computer storage media and communication media including any medium that facilitates transfer of a computer program from one place to another. A storage media may be any available media that can be accessed by a computer. By way of example, and not limitation, such non-transitory computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of non-transitory computer-readable media.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method comprising:
detecting a mobile device in a second orientation different from a first orientation based on images captured with a touchscreen of the mobile device; and
applying a first configuration to the mobile device when the mobile device is in the second orientation.

2. The method of claim 1, wherein detecting the mobile device in the second orientation different from the first orientation based on images captured with the touchscreen of the mobile device comprises:
capturing a first image with the touchscreen of the mobile device;
extracting user feature data for at least one user feature as depicted in the first image;
capturing a second image with the touchscreen of the mobile device;
extracting user feature data for the at least one user feature as depicted in the second image;
detecting a shift of the at least one user feature from the first image and the second image based on a comparison of the user feature data extracted from the first image with the user feature data extracted from the second image; and
wherein applying the first configuration to the mobile device when the mobile device is in the second orientation comprises applying the first configuration to the mobile device when the detected shift exceeds a threshold.

3. The method of claim 2, wherein the detected shift comprises a shift selected from a shift in location of the at least one user feature relative to the touchscreen of the mobile device, or a shift of the at least one user feature comprises a first rotation and the threshold is a first rotational movement threshold, or both.

4. The method of claim 3, further comprising:
capturing a third image with the touchscreen of the mobile device;
extracting user feature data for the at least one user feature as depicted in the third image;
determining a second rotation of the user feature from the second image and the third image;
determining when the second rotation exceeds a second rotational movement threshold; and
applying a second configuration to the mobile device when the detected shift exceeds the second rotational movement threshold.

5. The method of claim 4, further comprising:
incrementally adjusting a configuration of the mobile device towards the first configuration based on the first rotation; and
incrementally adjusting the configuration of the mobile device towards the second configuration based on the second rotation.

6. The method of claim 4, further comprising:
inferring that a position of an audio input of the mobile device has shifted from a talking to a non-talking position with respect to a mouth of a user based on the determination that the first rotation exceeds the first rotational movement threshold; and
inferring that the position of the audio input of the mobile device has shifted back to the talking position with respect to the mouth of the user based on the determination that the second rotation exceeds the second rotational movement threshold.

7. The method of claim 1, wherein applying the first configuration comprises the mobile device to process received audio data as a user command to configuration an application of the mobile device based on the received audio data.

8. The method of claim 1, wherein applying the first configuration to the mobile device comprises muting an audio input of the mobile device relative to a telephone conversation, and wherein the audio input of the mobile device is un-muted relative to the telephone conversation in response to application of a second configuration.

9. The method of claim 1, wherein the mobile device is a mobile telephone.

10. The method of claim 1, wherein applying the first configuration to the mobile device further comprises:
generating a notification to a user of the mobile device when the first configuration is applied, wherein the notification comprises one or more of an audio tone played to a user in an audio output of the mobile device, a visual indication of a state of the mobile device displayed by the mobile device, or a notification that causes the mobile device to vibrate, or any combination thereof.

11. The method of claim 1, wherein the user feature data comprises one or more of a tragus, an anti-tragus, a helix, an anti-helix, a lobe feature, or capacitive image profile data, or any combination thereof.

12. The method of claim 1, further comprising:
capturing one or more enrollment touchscreen images of a user prior to the call;
generating a user identifier from user feature data for at least one user feature extracted from the enrollment touchscreen images; and
associating the user with the generated user identification.

13. The method of claim 12, wherein the one or more enrollment touchscreen images comprise a first set of enrollment touchscreen images associated with a talking position of the mobile device.

14. The method of claim 13, wherein the one or more enrollment touchscreen images comprise a second set of enrollment touchscreen images associated with a non-talking position of the mobile device.

15. The method of claim 12, wherein the threshold is received as a user selection.

16. A non-transitory computer readable storage medium including instructions that, when executed by a processor, cause the processor to perform a method comprising:
detecting a mobile device in a second orientation different from a first orientation based on images captured with a touchscreen of the mobile device; and
applying a first configuration to the mobile device when the mobile device is in the second orientation.

17. The non-transitory computer readable storage medium of claim 16, wherein detecting the mobile device in the second orientation different from the first orientation based on images captured with a touchscreen of the mobile device comprises:
capturing a first image with a touchscreen of a mobile device;
extracting user feature data for at least one user feature as depicted in the first image;
capturing a second image with the touchscreen of the mobile device during the call;
extracting user feature data for the at least one user feature as depicted in the second image;
detecting a shift of the at least one user feature from the first image and the second image based on a comparison of the user feature data extracted from the first image with the user feature data extracted from the second image; and
wherein applying the first configuration to the mobile device when the mobile device is in the second orientation comprises applying the first configuration to the mobile device when the detected shift exceeds a threshold.

18. The non-transitory computer readable storage medium of claim 17, wherein the detected shift comprises a shift selected from a shift in location of the at least one user feature relative to the touchscreen of the mobile device, or a shift of the at least one user feature comprises a first rotation and the threshold is a first rotational movement threshold, or both.

19. The non-transitory computer readable storage medium of claim 18, the processor to perform the method further comprising:
capturing a third image with the touchscreen of the mobile device;
extracting user feature data for the at least one user feature as depicted in the third image;
determining a second rotation of the user feature from the second image and the third image;
determining when the second rotation exceeds a second rotational movement threshold; and
applying a second configuration to the mobile device when the detected shift exceeds the second rotational movement threshold.

20. The non-transitory computer readable storage medium of claim 19, the processor to perform the method further comprising:
inferring that a position of an audio input of the mobile device has shifted from a talking to a non-talking position with respect to a mouth of a user based on the determination that the first rotation exceeds the first rotational movement threshold; and
inferring that the position of the audio input of the mobile device has shifted back to the talking position with respect to the mouth of the user based on the determination that the second rotation exceeds the second rotational movement threshold.

21. The non-transitory computer-readable storage medium of claim 16, wherein applying the first configuration comprises the mobile device to process received audio data as a user command to configuration an application of the mobile device based on the received audio data.

22. The non-transitory computer readable storage medium of claim 16, wherein applying the first configuration to the mobile device comprises muting an audio input of the mobile device relative to a telephone conversation, and wherein the audio input of the mobile device is un-muted relative to the telephone conversation in response to application of a second configuration.

23. The non-transitory computer readable storage medium of claim 16, wherein the mobile device is a mobile telephone.

24. The non-transitory computer readable storage medium of claim 16, wherein applying the first configuration to the mobile device further comprises:
generating a notification to a user of the mobile device when the first configuration is applied, wherein the notification comprises one or more of an audio tone played to a user in an audio output of the mobile device, a visual indication of a state of the mobile device displayed by the mobile device, or a notification that causes the mobile device to vibrate, or any combination thereof.

25. The non-transitory computer readable storage medium of claim 16, wherein the user feature data comprises one or more of a tragus, an anti-tragus, a helix, an anti-helix, a lobe feature, or capacitive image profile data, or any combination thereof.

26. The non-transitory computer readable storage medium of claim 14, the processor to perform the method further comprising:
capturing one or more enrollment touchscreen images of a user prior to the call;
generating a user identifier from user feature data for at least one user feature extracted from the enrollment touchscreen images; and
associating the user with the generated user identification.

27. A mobile device, comprising:
a touchscreen to capture one or more touchscreen images;
a memory coupled to the touchscreen to store the one or more touchscreen images; and
a processor, coupled with the memory and the touchscreen, configured to
detect the mobile device in a second orientation different from a first orientation based on images captured with a touchscreen of the mobile device, and
apply a first configuration to the mobile device when the mobile device is in the second orientation.

28. The mobile device of claim 27, wherein detection of the mobile device in the second orientation different from the first orientation based on images captured with the touchscreen of the mobile device comprises the processor configured to:
capture a first image with the touchscreen,
extract user feature data for at least one user feature as depicted in the first image,
capture a second image with the touchscreen,
extract user feature data for the at least one user feature as depicted in the second image,
detect a shift of the at least one user feature from the first image and the second image based on a comparison of the user feature data extracted from the first image with the user feature data extracted from the second image, and
wherein application of the first configuration to the mobile device when the mobile device is in the second orientation comprises the processor configured to apply the first configuration to the mobile device when the detected shift exceeds a threshold.

29. An apparatus, comprising means for muting a phone relative to a telephone conversation based on a rotation of the phone away from a mouth of a speaker.

30. The apparatus of claim 29, wherein the means for muting a phone based on the rotation of the phone away from the mouth of the speaker comprises:
means for capturing a first image with a touchscreen of a mobile device;
means for extracting user feature data for at least one user feature as depicted in the first image;
means for capturing a second image with the touchscreen of the mobile device;
means for extracting user feature data for the at least one user feature as depicted in the second image;
means for detecting a shift of the at least one user feature from the first image and the second image based on a comparison of the user feature data extracted from the first image with the user feature data extracted from the second image; and
means for applying a first configuration to the mobile device when the detected shift exceeds a threshold.
